(19) United States
(12) Patent Application Publication
(10) Pub. No.: US 2013/0143625 A1
(43) Pub. Date: Jun. 6, 2013

(54) Speed Dialing Method, Subscriber Identity Module/User Identity Model and Mobile Terminal

(71) Applicant: Pengren Wang, Shenzhen (CN)

(72) Inventor: Pengren Wang, Shenzhen (CN)

(73) Assignee: ZTE CORPORATION, Shenzhen, Guangdong Province (CN)

(21) Appl. No.: 13/813,489

(22) PCT Filed: Jan. 12, 2011
(86) PCT No.: PCT/CN2011/070197

§ 371 Date: Jan. 31, 2013

(30) Foreign Application Priority Data
Aug. 18, 2010 (CN) 201010261720.5

(51) Int. Cl. H04M 1/275

(52) U.S. Cl. CPC H04M 1/275
USPC 455/564

(57) ABSTRACT

The disclosure claims a speed dialing method, a Subscriber Identity Module/User Identity Model (SIM/UIM) and a mobile terminal. A contact number field on the SIM/UIM is divided into two fields. One field is used for storing the contact numbers, and the other is the speed dialing position field configured to store the speed dialing information of contacts (101). 0XFF characters are set between the two fields for separating the two fields (102). After speed dialing of the contacts in the SIM/UIM is set, the speed dialing can be commonly used in different mobile terminals. The universality of the speed dialing functions is added. And, ID and speed dialing information recorded by the contacts on the SIM/UIM is written in mobile terminal. Then the name and the speed dialing information of the contacts is obtained only according to the contact ID when needing to be loaded.

### FIELD OF THE INVENTION

The disclosure relates to the field of communications, and in particular to a method of implementing speed dialing for contacts in a Subscriber Identity Module/User Identity Model (SIM/UIM), an SIM/UIM and a mobile terminal.

### BACKGROUND OF THE INVENTION

With the development and progress of the wireless communication technology, the mobile terminals such as mobile phones etc. become more and more intelligent and humanized in terms of satisfying the needs of users. Users can implement more functions with fewer operations. Every large terminal manufacturer is committed to improving the user experience, so as to bring more convenience for the lives of the users.

At present, the speed dialing function has become a necessary and important function of the mobile phone. Via the speed dialing, the users can set the frequently-used contacts or emergency call numbers in the name card holder on an appointed number key of the mobile phone. When the user needs to call the number, the number can be called by only long pressing a speed dialing key corresponding to the number (for the mobile phone which has more than 10 speed dialing positions, usually it needs to press the number key corresponding to the speed dialing, and then press the calling key). The function can greatly improve the usability of the mobile phone and the user experience.

The SIM/UIM provided for the user by the operator represents different user identity information. The user establishes contact with other contacts via the SIM/UIM and the unique number of the SIM/UIM. The record for storing the contact information of the phone book in the SIM/UIM is called the Abbreviated Dialing Number (ADN) record in the SIM, UIM cards.

The current ADN record structure supported in the protocol is as shown in Table 1:

TABLE 1

| | Field Identification (ID) | | | | | |
|---|---|---|---|---|---|---|
| | A | B | C | D | E | F |
| Field | Name | Total | TON | Number | Capability or | Extended |
| usage | | length of C, D | and | | configuration | record ID |
| | | fields | NPI | | ID | |

In Table 1, the length of the field A for storing the contact names in the SIM, UIM cards is changeable. The length is determined by the types of the SIM/UIM and the manufacturers of the card, and is within the range of 0-241.

The field D is configured to store the contact numbers. The field D adopts the BCD encoding mode. The length of the field D is determined by the types of the SIM/UIM, and is generally within the range of 0-50.

Due to the limit of storage structure for storing the ADN record on the SIM/UIM, the contacts on the card cannot implement the same speed dialing setting as the contacts on the mobile phone. The ADN record for storing the contact records of the phone book in the SIM, UIM cards only provides two fields which are capable of storing the contact information records, namely, the name field and the number field. Therefore, currently the contact records stored in the phone book of the SIM/UIM of the user phone cannot support the frequently-used speed dialing functions.

There are phone types which can set speed dialing for the contact records of the phone book in the SIM/UIM cards in the related mobile phones. The solution of these phone types is to create a speed dialing information index file in the mobile phone file system, for recording a corresponding relationship between the contact ID on the phone book and the speed dialing information, so as to realize the function of setting the speed dialing for the contact records of the phone book in the SIM, UIM cards.

It can be seen from the above solution, the speed dialing information of the contacts in the phone book of the SIM, UIM cards is stored on the mobile phone, but not the SIM/UIM. Thus, when the user changes the mobile phone, the former speed dialing information of the contacts on the SIM/UIM will be lost, which causes inconvenience for the user, and makes the user experience poor.

### SUMMARY OF THE INVENTION

The disclosure provides a speed dialing method, a SIM/UIM and a mobile terminal. The solution of the disclosure can prevent the lost of the speed dialing information of the contacts previously stored in the SIM/UIM and can improve the user experience, when changing the mobile terminal for the SIM/UIM.

To solve the technical problems, the disclosure adopts the following technical solutions.

The disclosure provides a speed dialing method comprising the following solutions.

The method of setting speed dialing for a contact in a Subscriber Identity Module/User Identity Model (SIM/UIM), comprises:

dividing a contact number field on the SIM/UIM into two fields, wherein one field is a field configured to store a contact number, and the other field is a speed dialing position field configured to store speed dialing information of the contact; and

setting a separating character between the two fields.

The method of implementing speed dialing for a contact in an SIM/UIM comprises: dividing a contact number field on the SIM/UIM into two fields, wherein one field is a field configured to store a contact number, and the other field is a speed dialing position field configured to store speed dialing information of the contact; and setting a separating character between the two fields to separate the two fields; and

reading the speed dialing information of the speed dialing position field of the SIM/UIM when initially reading contact information of the SIM/UIM;

writing the speed dialing information and a contact Identification (ID) corresponding to the speed dialing information into a mobile terminal; and

receiving a user instruction, and reading, according to the user instruction, the speed dialing information of the contact on the SIM/UIM which is written in the mobile terminal.

Reading, according to the user instruction, the speed dialing information of the contact on the SIM/UIM which is written in the mobile terminal comprises:

acquiring the contact number corresponding to the contact ID;

acquiring the speed dialing information corresponding to the contact ID; and

matching the contact number corresponding to the contact ID and the speed dialing information corresponding to the contact ID to obtain the speed dialing information corresponding to the contact number.

Receiving the user instruction, and reading, according to the user instruction, the speed dialing information of the contact on the SIM/UIM which is written in the mobile terminal comprises:

receiving an instruction from a user of searching for all the speed dialing, and loading all the speed dialing information of contacts on the SIM/UIM which is stored in the mobile terminal; or,

receiving an instruction from the user of calling out by speed dialing, searching, in accordance with the speed dialing information indicated by information of a way of the user pressing keys, for the contact ID corresponding to the speed dialing information, and calling out the contact after completing the search.

The SIM/UIM according to the disclosure comprises:

a field setting unit, configured to divide a contact number field on the SIM/UIM into two fields, wherein one field is a field configured to store a contact number, and the other field is a speed dialing position field configured to store speed dialing information of a contact; and

a character setting unit, configured to set a separating character between the two fields to separate the two fields.

In the mobile terminal according to the disclosure, a contact number field on a Subscriber Identity Module/User Identity Model (SIM/UIM) of the mobile terminal is divided into two fields, wherein one field is a field configured to store a contact number, and the other field is a speed dialing position field configured to store speed dialing information of a contact, and a separating character is set between the two fields to separate the two fields; and the mobile terminal further comprises:

a first information reading unit, configured to read the speed dialing information of the speed dialing position field of the contact on the SIM/UIM when initially reading contact information of the SIM/UIM;

an information writing unit, configured to write the speed dialing information and a contact Identification (ID) corresponding to the speed dialing information into the mobile terminal; and

a second information reading unit, configured to receive a user instruction, and read, according to the user instruction, the speed dialing information of the contact on the SIM/UIM which is written in the mobile terminal.

The second information reading unit is further configured to receive an instruction from a user of searching for all speed dialing, and load all the speed dialing information of contacts on the SIM/UIM which is stored in the mobile terminal; or,

to receive an instruction from the user of calling out by speed dialing, search, in accordance with the speed dialing information indicated by information of a way of the user pressing keys, for the contact ID corresponding to the speed dialing information, and call out the contact after completing the search.

The second information reading unit is further configured to acquire the contact number corresponding to the contact ID, acquire the speed dialing information corresponding to the contact ID, and match the contact number corresponding to the contact ID and the speed dialing information corresponding to the contact ID to obtain the speed dialing information corresponding to the contact number.

The technical solution of the disclosure has the following advantages. The disclosure provides a method of setting speed dialing for the contacts in the SIM/UIM, a method of implementing speed dialing for the contacts in the SIM/UIM, a related SIM/UIM and a mobile phone. After setting the speed dialing for the contacts in the SIM/UIM, the speed dialing can be commonly used in different mobile terminals, realizing the universality of the speed dialing function. In addition, the mobile terminal writes the contact ID and the speed dialing information on the SIM/UIM into the mobile terminal itself. Then the contact name, the contact number and the speed dialing information can be obtained according to the contact ID when it is needed to be loaded. Thereby, the efficiency of reading the speed dialing information of the contacts on the SIM/UIM by the mobile terminal is greatly improved. It does not need to read the SIM/UIM each time when searching for the speed dialing list or matching the contact. If the contact information recorded on the SIM/UIM changes, it only needs to maintain the speed dialing information recorded in the mobile terminal synchronously.

### BRIEF DESCRIPTION OF THE DRAWINGS

FIG. 1 shows a flowchart of a method for setting speed dialing for the contacts in the SIM/UIM according to the embodiment I of the disclosure;

FIG. 2 shows a flowchart of a method for implementing speed dialing for the contacts in the SIM/UIM according to the embodiment II of the disclosure;

FIG. 3 shows a flowchart of an application for setting speed dialing for the contacts in the SIM/UIM according to the embodiment of the disclosure;

FIG. 4 shows a flowchart of loading the speed dialing information in the SIM/UIM according to the embodiment of the disclosure;

FIG. 5 shows a flow of storing the speed dialing information in the SIM/UIM according to the embodiment of the disclosure;

FIG. 6 shows a flowchart of identifying the user instructions according to the embodiment of the disclosure;

FIG. 7 shows a flowchart of matching the speed dialing information according to the embodiment of the disclosure;

FIG. 8 shows a structural diagram of the SIM/UIM according to the embodiment of the disclosure; and

FIG. 9 shows a structural diagram of the mobile terminal according to the embodiment of the disclosure.

The implementation of the purpose, functional characteristics and advantages of the disclosure is further described below with reference to the embodiments and the drawings.

### DETAILED DESCRIPTION OF THE EMBODIMENTS

In order to further illustrate the purpose, the technical solution and the advantages of the disclosure, the disclosure is further described in detail hereinafter with reference to the drawings and embodiments. It should be understood that the embodiments described herein are only for explaining the disclosure, but not for limiting the disclosure.

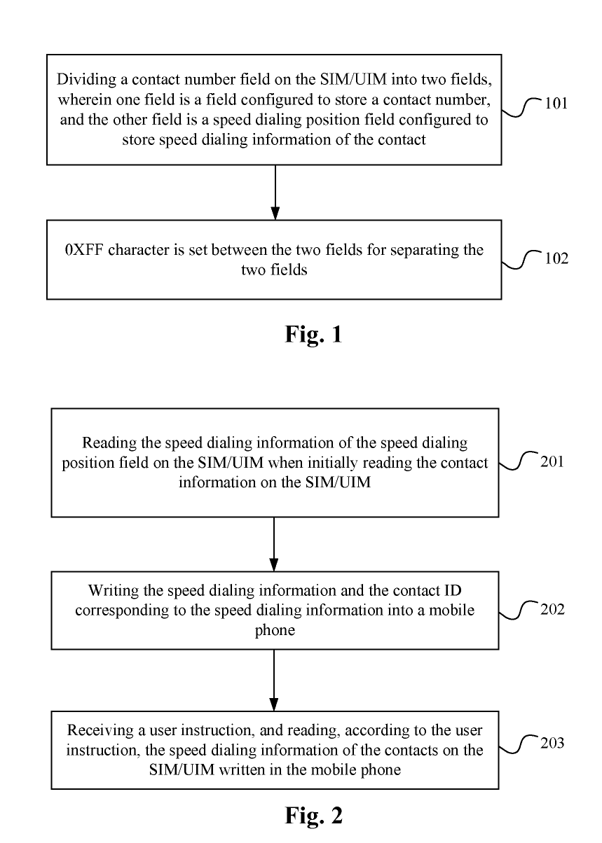

The embodiment I of the disclosure provides a method of setting speed dialing for the contacts in the SIM/UIM. As shown in FIG. 1, the method comprises the following steps.

Step 101, dividing a contact number field on the SIM/UIM into two fields, wherein one field is a field configured to store a contact number, and the other field is a speed dialing position field configured to store speed dialing information of the contact, wherein the speed dialing information is the speed dialing information corresponding to the contact number of the phone book of the SIM/UIM.

The speed dialing position field can occupy one byte, namely, 8 bits. The number of the speed dialing positions is between 0 and 255. That is, maximally 256 speed dialing positions can be stored.

Step 102, setting a separating character between the two fields in Step 101 to separate the two fields.

In the above, the separating character can be set as 0XFF. At least one 0XFF is needed for distinguishing the contents of the two fields.

The modified ADN structure is as shown in Table 2:

TABLE 2

| Field ID | D | | |
|---|---|---|---|
| Field length | D field length-2 | 1 | 1 |
| Field usage | Contact number | Field separator | Speed dialing |
| | field | 0XFF | position field |

After setting the speed dialing for the contacts in the SIM/UIM, the method according to the embodiment of the disclosure can be commonly used in different mobile phones. Thereby, the universality of the speed dialing function can be added.

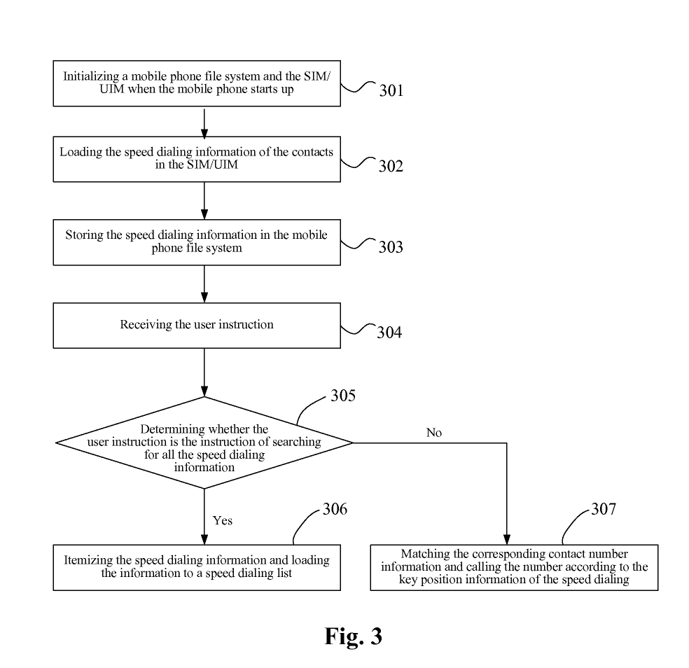

The embodiment of the disclosure further provides a method for implementing the speed dialing for the contacts in the SIM/UIM, based on the solution of the embodiment I as shown in FIG. 1: the contact number field on the SIM/UIM is divided into two fields, wherein one field is a field configured to store a contact number, and the other field is a speed dialing position field configured to store speed dialing information of the contact; and the 0XFF character is set between the two fields for separating the two fields. As shown in FIG. 2, the method comprises the following steps.

Step 201, reading the speed dialing information of the speed dialing position field of the SIM/UIM when initially reading the contact information on the SIM/UIM. Specifically, the speed dialing information is the speed dialing position information.

Step 202, writing the speed dialing information and the contact ID corresponding to the speed dialing information into the mobile phone. Specifically, the read speed dialing information and the read contact ID corresponding to the speed dialing information can be written into a file for storing the speed dialing information of the contacts on the SIM/UIM in the mobile phone file system. Thus, the efficiency of reading the speed dialing records of the contacts on the SIM/UIM via the mobile phone is improved.

In the above, the method according to the embodiment follows the principle that the speed dialing information in the mobile phone has priority. Thus, the speed dialing information in the mobile phone is read first, and then the speed dialing information on the SIM/UIM is load. Once the corresponding contact information is loaded on a speed dialing position, the speed dialing information on the SIM/UIM of the same position cannot be loaded any more.

Step 203, receiving the user instruction, and reading, according to the user instruction, the speed dialing information of the contacts on the SIM/UIM written in the mobile phone. That is, the mobile phone acquires the contact number corresponding to the contact ID, acquires the speed dialing information corresponding to the contact ID, and then matches the contact number corresponding to the contact ID and the speed dialing information corresponding to the contact ID to obtain the speed dialing information corresponding to the contact number. Step 203 can further comprise:

if the instruction of searching for all the speed dialing is received from the user, loading all the speed dialing information of the contacts on the SIM/UIM which is stored in the mobile phone; or,

if the instruction of calling out by speed dialing is received from the user, searching for the contact ID corresponding to the speed dialing information in accordance with the speed dialing information indicated by information of the way of the user pressing the keys, and after completing the search, calling out the contact.

With the method according to the embodiment, the recorded contact ID on the SIM/UIM and the speed dialing information are written into the mobile phone via the mobile phone. Then the contact name and the speed dialing information can be obtained only according to the contact ID when it is needed to be loaded. Thereby, the efficiency of reading the speed dialing information of the contacts on the SIM/UIM by the mobile phone is greatly improved. And it is unnecessary to read the SIM/UIM each time when searching for the speed dialing list or matching the contacts.

The method for implementing speed dialing for the contacts on the SIM/UIM is described below in combination with application of the embodiment. FIG. 3 shows an application flowchart of setting speed dialing for the contacts in the SIM/UIM according to the embodiment of the disclosure, comprising the following steps.

Step 301, initializing the mobile phone file system and the SIM/UIM when the mobile phone starts up. The contact information in the mobile phone and the contact information in the SIM/UIM is respectively loaded. Currently, the storage of the number type of the contacts in the UIM card is not supported.

Step 302, loading the speed dialing information of the contacts in the SIM/UIM.

In the current Code Division Multiple Access (CDMA) mobile phones, the contact information in the mobile phone and the UIM card is loaded by itemization and reading in a circulation mode. When loading the number field of the contact information, it is determined whether the last byte of the number field is 0XFF. If the last byte is not 0XFF, it is determined whether the former byte is 0XFF. If the former byte is 0XFF, the last byte is read as the speed dialing position. If the former byte is not 0XFF, it represents that no speed dialing field exists in the SIM/UIM.

Step 303, storing the speed dialing information in the mobile phone file system.

After reading the speed dialing information on the SIM/UIM, the current contact ID and the corresponding speed dialing information is written into the mobile phone file system with fixed number of bytes.

Step 304, receiving the user instruction.

The instruction event sent by the user is received. The type of the instruction sent by the user is distinguished according to the event ID, so as to implement different subsequent processing.

Step 305, determining whether the user instruction is the instruction of searching for all the speed dialing information. If yes, all the corresponding contact information for which the speed dialing information has been set is loaded. If not, the contact information is matched according to the specific speed dialing information.

Step 306, itemizing the speed dialing information and loading the information to the speed dialing list.

During the process of itemizing the speed dialing information, first the speed dialing information on the mobile phone is read. Then the speed dialing information on the SIM/UIM is read. In this case, there is the problem that the speed dialing information stored on the mobile phone and the speed dialing information stored on the SIM/UIM are repeatedly set. For this problem, it defaults to load the contact information corresponding to the speed dialing information on the mobile phone. If certain speed dialing information exists, the speed dialing information is not read again when reading the contact information of the SIM/UIM.

Step 307, matching the corresponding contact number and calling the number according to the key position information of the speed dialing.

According to the specific key position information of the speed dialing, searching for the speed dialing information in the mobile phone and the speed dialing information on the SIM/UIM respectively is performed. During the matching and searching process, there also is the problem that the speed dialing information stored on the mobile phone and the speed dialing information stored on the SIM/UIM are repeatedly set. Similarly, the principle that the speed dialing information in the mobile phone has priority is followed. Once the corresponding contact information is found, the information is returned immediately, and no continuous searching is implemented any more.

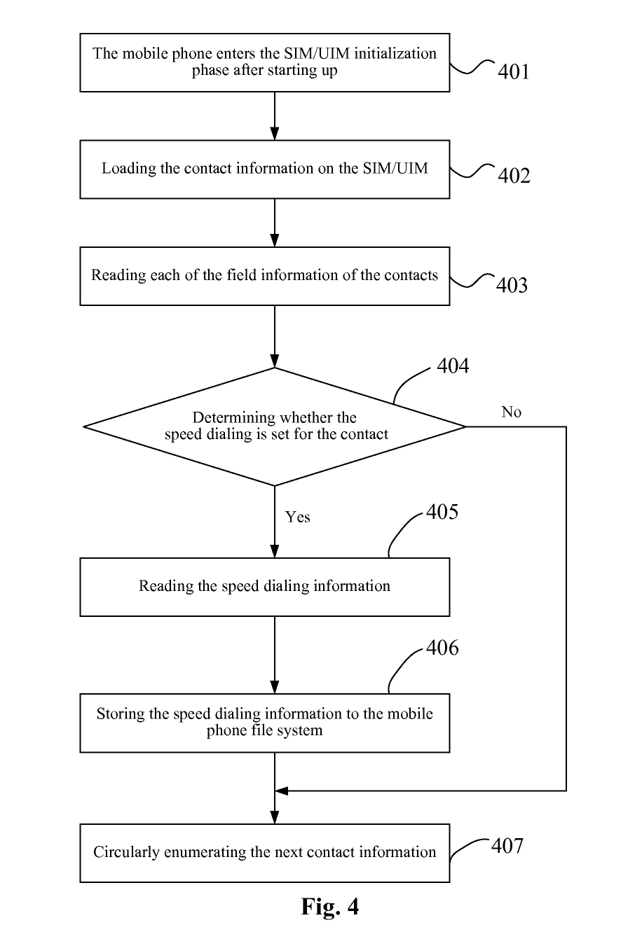

FIG. 4 shows a flowchart of putting and loading the speed dialing information in the SIM/UIM according to the embodiment of the disclosure, comprising the following steps.

Step 401, entering the initialization phase of the SIM/UIM after the mobile phone starts up. The initialization phase is the phase that the mobile phone reads the contact information on the SIM/UIM.

Step 402, loading the contact information on the SIM/UIM. It is mainly to initially load the objects of name card holders, so as to make preparations for circularly loading the contact information.

Step 403, reading the information of each field of the contact. The field information comprises a contact name field, a number field and a speed dialing position field.

Step 404, determining whether the speed dialing is set for the contact.

Here, it is determined whether the read speed dialing position field is 0XFF, and it is determined whether the last byte of the number field is 0XFF, so as to distinguish whether the current SIM/UIM supports the speed dialing position field. If the speed dialing position field is not set in the SIM/UIM, Step S407 is executed.

Step 405, reading the speed dialing information. If the speed dialing field has been set, the current speed dialing information of the contact is read.

Step 406, storing the speed dialing information into the mobile phone file system.

Step 407, circularly enumerating the next contact information.

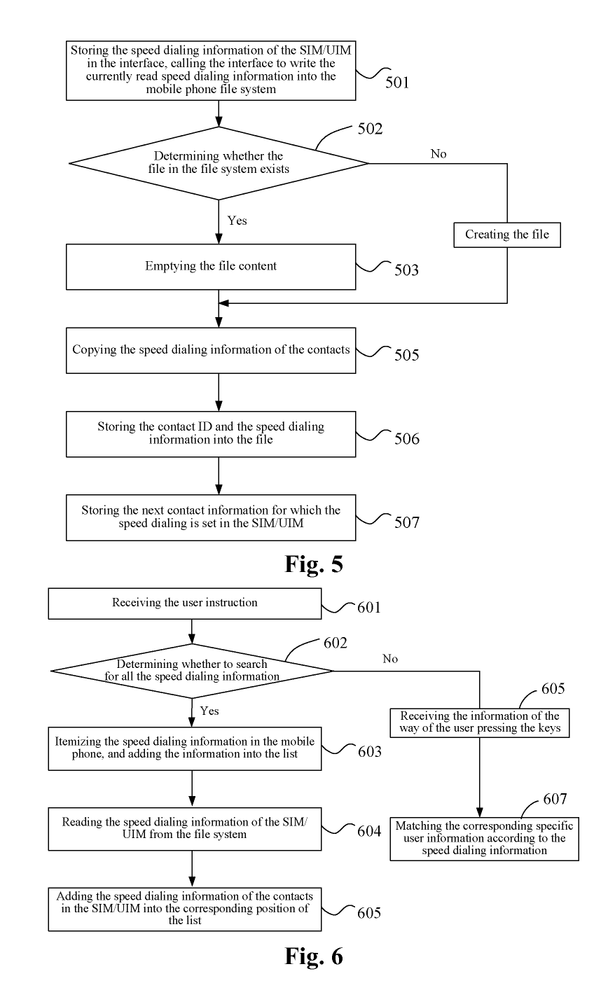

FIG. 5 shows a flowchart of storing the speed dialing information in the SIM/UIM according to the embodiment of the disclosure, comprising the following steps.

Step 501, storing the speed dialing information of the SIM/UIM in the interface, calling the interface to write the currently read speed dialing information into the mobile phone file system.

Step 502, determining whether the file in the file system exists. It is mainly to determine whether it is the first time to load the speed dialing information of the contacts in the SIM/UIM. If the file exists, Step 503 is executed; and if not, Step 504 is executed.

Step 503, emptying the file content.

If it is not the first time to load, the content of the original file in the file system needs to be removed.

It is mainly to prevent the condition that the mobile phone changes the card again or the SIM/UIM is inserted into the current mobile phone after being operated in other mobile phones.

Step 504, creating a file. If it is the first time to load, an empty file is created to prepare for the subsequent writing.

Step 505, copying the speed dialing information of the contacts. The specific speed dialing information of the contacts which has been read is copied inside the interface.

Step 506, storing the contact ID and the speed dialing information into the file.

The contact ID and the speed dialing information is written into the file according to fixed number of bytes. If the bytes are not enough, 0 is filled in to complete the file. Here, it is required to write fixed number of bytes, mainly to improve the efficiency for subsequently operating the contact information (reading, modification, deletion etc.). The reading, modification and deletion for the speed dialing position and the contact ID in the card can be fast completed only by operating the file content according to the fixed bytes.

Step 507, storing the next contact information for which the speed dialing is set in the SIM/UIM.

FIG. 6 shows a flowchart of distinguishing the user instruction according to the embodiment of the disclosure, comprising the following steps.

Step 601, receiving the user instruction.

Step 602, determining whether to search for all the speed dialing information according to the user instruction. If yes, Step 603 is executed; and if not, Step 606 is executed.

Step 603, itemizing the speed dialing information in the mobile phone and adding the information to the list.

Step 604, reading the speed dialing information of the SIM/UIM from the file system.

Step 605, adding the speed dialing information of the contacts in the SIM/UIM to the corresponding position of the list. If the position has been set as the speed dialing in the mobile phone, the speed dialing information in the SIM/UIM is not added again.

Step 606, receiving the information of the way of the user pressing the keys. The information of the way of the user pressing the keys is corresponding to the speed dialing information, that is, the speed dialing information corresponding to the contact that the user wants to call out.

Step 607, matching the corresponding specific contact information according to the speed dialing information.

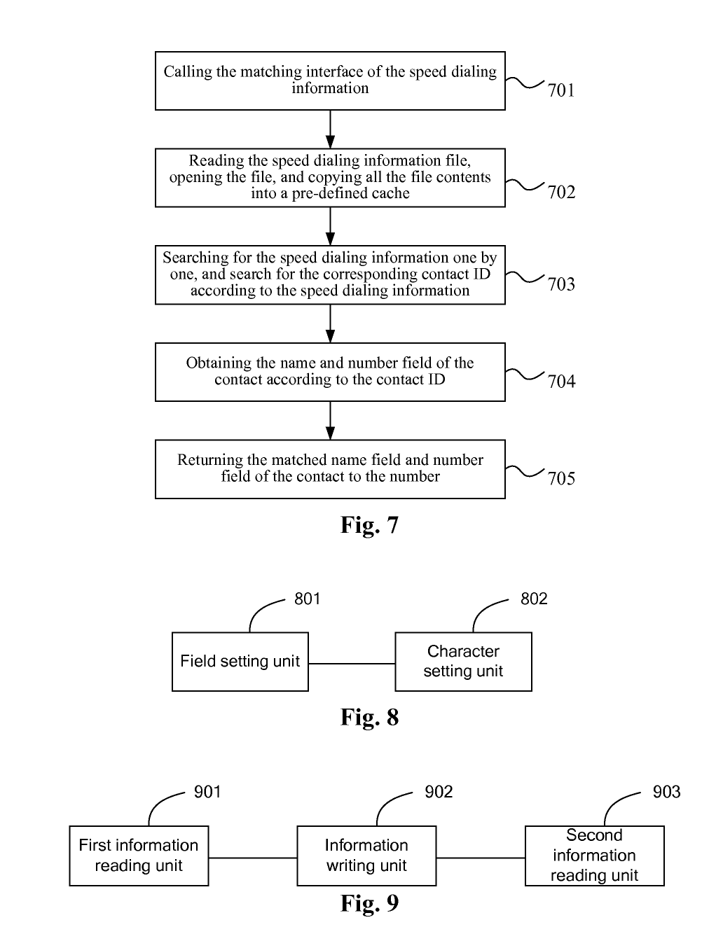

FIG. 7 shows a flowchart of matching the speed dialing information according to the embodiment of the disclosure, comprising the following steps.

Step 701, calling the matching interface of the speed dialing information.

Step 702, reading the speed dialing information file, opening the file, and copying all the file contents to the pre-defined cache.

Step 703, searching for the speed dialing information one by one, and finding the corresponding contact ID according to the speed dialing information. Matching is performed in the cache obtained in Step 702 one by one according to the speed dialing information, and the contact ID corresponding to the speed dialing information is searched for.

Step 704, obtaining the contact name field and the number field according to the contact ID, and matching the obtained contact name field and the number field.

Step 705, returning the matched contact name field and number field to the number.

As shown in FIG. 8, the embodiment of the disclosure also provides an SIM/UIM, comprising:

a field setting unit 801, configured to divide the contact number field on the SIM/UIM into two fields, wherein one field is a field configured to store a contact number, and the other field is configured to be a corresponding speed dialing position field of the contact number of the phone book; and

a character setting unit 802, configured to set a separating character between the two fields to separate the two fields.

After setting the speed dialing for the contacts in the SIM/UIM according to the embodiment, the speed dialing can be commonly used in different mobile phones, and the universality of the speed dialing function is improved.

As shown in FIG. 9, the embodiment of the disclosure also provides a mobile phone. The contact number field on the SIM/UIM of the mobile phone is divided into two fields, wherein one field is a field configured to store a contact number, and the other field is configured to be a corresponding speed dialing position field of the contact number of the phone book. A separating character is set between the two fields to separate the two fields. The mobile phone comprises:

a first information reading unit 901, configured to read the speed dialing information of the speed dialing position field of the contacts on the SIM/UIM when initially reading the contact information on the SIM/UIM;

an information writing unit 902, configured to write the read speed dialing information and the contact ID corresponding to the speed dialing information into the mobile phone; and

a second information reading unit 903, configured to receive the user instruction, and read, according to the user instruction, the speed dialing information of the contacts on the SIM/UIM which is written in the mobile phone. That is, the second information reading unit is configured to obtain the contact number corresponding to the contact ID, obtain the speed dialing information corresponding to the contact ID, and match the contact number corresponding to the contact ID and the speed dialing information corresponding to the contact ID to obtain the speed dialing information corresponding to the contact number.

In another embodiment, the second information reading unit 903 is further configured to:

if the instruction of searching for all the speed dialing is received from the user, load all the speed dialing information of the contacts on the SIM/UIM stored in the mobile phone; or,

if the instruction of calling out by speed dialing is received from the user, search for the contact ID corresponding to the speed dialing information in accordance with the speed dialing information indicated by information of the way of the user pressing the keys, and after completing the search, call out the contact.

The mobile phone according to the embodiment writes the recorded contact ID and the speed dialing information on the SIM/UIM into the mobile phone itself. The name and the speed dialing information of the contact can be obtained only according to the contact ID when it is needed to be loaded. Thereby, the efficiency of reading the speed dialing information of the contacts on the SIM/UIM by the mobile phone is greatly improved. And it is unnecessary to read the SIM/UIM each time when searching for the speed dialing list or matching the contacts. If the contact information recorded on the SIM/UIM changes, the speed dialing information recorded in the mobile phone only needs to be maintained at the same time.

The above are only the preferred embodiments of the disclosure and not intended to limit the disclosure. Any modifications, equivalent replacements, improvements within the principle of the disclosure shall fall within the scope of protection of the disclosure.

1. A method of speed dialing for a contact in a Subscriber Identity Module/User Identity Model (SIM/UIM), comprising:
dividing a contact number field on the SIM/UIM into two fields, wherein one field is a field configured to store a contact number, and the other field is a speed dialing position field configured to store speed dialing information of the contact; and
setting a separating character between the two fields.

2. The method according to claim 1, further comprising:
reading the speed dialing information of the speed dialing position field of the SIM/UIM when initially reading contact information of the SIM/UIM;
writing the speed dialing information and a contact Identification (ID) corresponding to the speed dialing information into a mobile terminal; and
receiving a user instruction, and reading, according to the user instruction, the speed dialing information of the contact on the SIM/UIM which is written in the mobile terminal.

3. The method according to claim 2, wherein reading, according to the user instruction, the speed dialing information of the contact on the SIM/UIM which is written in the mobile terminal comprises:
acquiring the contact number corresponding to the contact ID;
acquiring the speed dialing information corresponding to the contact ID; and
matching the contact number corresponding to the contact ID and the speed dialing information corresponding to the contact ID to obtain the speed dialing information corresponding to the contact number.

4. The method according to claim 2, wherein receiving the user instruction, and reading, according to the user instruction, the speed dialing information of the contact on the SIM/UIM which is written in the mobile terminal comprises:
receiving an instruction from a user of searching for all the speed dialing, and loading all the speed dialing information of contacts on the SIM/UIM which is stored in the mobile terminal; or,
receiving an instruction from the user of calling out by speed dialing, searching, in accordance with the speed dialing information indicated by information of a way of the user pressing keys, for the contact ID corresponding to the speed dialing information, and calling out the contact after completing the search.

5. A Subscriber Identity Module/User Identity Model (SIM/UIM), comprising:
a field setting unit, configured to divide a contact number field on the SIM/UIM into two fields, wherein one field is a field configured to store a contact number, and the other field is a speed dialing position field configured to store speed dialing information of a contact; and
a character setting unit, configured to set a separating character between the two fields to separate the two fields.

6. A mobile terminal, wherein a contact number field on a Subscriber Identity Module/User Identity Model (SIM/UIM) of the mobile terminal is divided into two fields, wherein one field is a field configured to store a contact number, and the other field is a speed dialing position field configured to store speed dialing information of a contact, and a separating character is set between the two fields to separate the two fields; and the mobile terminal further comprises:
a first information reading unit, configured to read the speed dialing information of the speed dialing position field of the contact on the SIM/UIM when initially reading contact information of the SIM/UIM;
an information writing unit, configured to write the speed dialing information and a contact Identification (ID) corresponding to the speed dialing information into the mobile terminal; and
a second information reading unit, configured to receive a user instruction, and read, according to the user instruction, the speed dialing information of the contact on the SIM/UIM which is written in the mobile terminal.

7. The mobile terminal according to claim 6, wherein the second information reading unit is further configured to receive an instruction from a user of searching for all speed dialing, and load all the speed dialing information of contacts on the SIM/UIM which is stored in the mobile terminal; or,
to receive an instruction from the user of calling out by speed dialing, search, in accordance with the speed dialing information indicated by information of a way of the user pressing keys, for the contact ID corresponding to the speed dialing information, and call out the contact after completing the search.

8. The mobile terminal according to claim 6, wherein
the second information reading unit is further configured to acquire the contact number corresponding to the contact ID, acquire the speed dialing information corresponding to the contact ID, and match the contact number corresponding to the contact ID and the speed dialing information corresponding to the contact ID to obtain the speed dialing information corresponding to the contact number.
